(19) United States
(12) Patent Application Publication
(10) Pub. No.: US 2024/0392115 A1
(43) Pub. Date: Nov. 28, 2024

(54) CROSS-LINKABLE RUBBER MIXTURE AND PNEUMATIC VEHICLE TYRE

(71) Applicant: Continental Reifen Deutschland GmbH, Hannover (DE)

(72) Inventors: Sebastian Finger, Hannover (DE); Fabian Peters, Hannover (DE); Carla Recker, Hannover (DE); Catarina Sà, Isernhagen (DE)

(73) Assignee: Continental Reifen Deutschland GmbH, Hannover (DE)

(21) Appl. No.: 18/246,150

(22) PCT Filed: Sep. 10, 2021
(86) PCT No.: PCT/DE2021/200122

§ 371 Date: Mar. 21, 2023

(30) Foreign Application Priority Data
Sep. 21, 2020 (DE) 10 2020 211 749.7

(51) Int. Cl. C08L 9/06; B60C 1/00; C08C 19/25; C08K 3/36; C08L 25/16

(52) U.S. Cl. CPC C08L 9/06; B60C 1/0016; C08C 19/25; C08K 3/36; C08L 25/16; C08L 2205/025; C08L 2205/03

(57) ABSTRACT

The invention relates to a crosslinkable rubber mixture comprising:
a. a diene rubber having an average molar mass of more than 150 000 g/mol,
b. a filler,
c. a polymer or oligomer having an average molar mass Mn of less than 150 000 g/mol, which has a filler-interactive functional group and a glass transition temperature T_{g}<−15° C.,
d. a polymer or oligomer having an average molar mass Mn of less than 150 000 g/mol, which has a filler-interactive functional group and a glass transition temperature Tg>−15° C.

The invention relates to a crosslinkable rubber mixture and to a pneumatic vehicle tire comprising at least one tire component made of rubber and at least partially manufactured from this rubber mixture.

### BRIEF SUMMARY OF THE INVENTION

A known way of optimizing the physical properties of the vulcanizates that are manufactured from rubber mixtures and form, for example, constituents of pneumatic vehicle tires or industrial rubber articles, such as cords, belts and hoses, is to vary the mixture constituents of the rubber mixtures. It is frequently possible by varying a mixture constituent to improve a vulcanizate property, with simultaneous occurrence of deterioration in another vulcanizate property, such that there is a trade-off between these two vulcanizate properties. Such a trade-off exists in treads of pneumatic vehicle tires between rolling resistance, wet grip properties and attrition resistance.

A known way of influencing rolling resistance, wet grip properties and attrition resistance of treads is, for example, to use styrene-butadiene rubbers with different microstructure or modified styrene-butadiene rubbers in the underlying rubber mixture(s). Especially in the case of the styrene-butadiene rubbers, the styrene content and vinyl content are varied, the end groups are modified or couplings or hydrogenations are undertaken.

EP 2 060 604 B1 discloses, for example, a rubber mixture which is especially intended for a tread of a pneumatic vehicle tire, containing a filler and a low molecular weight diene rubber having an average molar mass Mw (mass-average molar mass) of 2000 g/mol to 150 000 g/mol and a content of aromatic vinyl compounds of less than 5%. A tread manufactured from such a rubber mixture is said to have low rolling resistance.

WO 2018/191187 A1, moreover, discloses a rubber mixture containing a functionalized resin with a polar linker. The rubber mixture is used, for example, in the production of a hose, a gasket, a belt, a footwear sole or a tire component, especially a tread or a sidewall.

It has not been possible with the rubber mixtures known to date to satisfactorily resolve the trade-off that exists in treads of pneumatic vehicle tires between low rolling resistance, good wet grip properties and high attrition resistance.

The problem addressed by the invention is therefore that of providing a rubber mixture for a tread of a pneumatic vehicle tire by means of which a better resolution of the trade-off between rolling resistance, wet grip properties and attrition resistance is possible than to date.

This is effected according to the invention by a crosslinkable rubber mixture containing:
a) a diene rubber having an average molar mass of more than 150 000 g/mol,
b) a filler,
c) a polymer or oligomer having an average molar mass Mn of less than 150 000 g/mol, which has a filler-interactive functional group and a glass transition temperature T_{g}<−15° C.,
d) a polymer or oligomer having an average molar mass Mn of less than 150 000 g/mol, which has a filler-interactive functional group and a glass transition temperature Tg>−15° C.

In such a rubber mixture, the mixture constituents endowed with a filler-interactive functional group, namely components c) and d), have increased interaction with the filler and create an interface between the polymer or oligomer and the filler. The combination of filler-interactive polymers and/or oligomers having different glass transition temperatures optimizes the properties of this interface, especially in a manner matched to the respective application of the rubber mixture. In test series that we have conducted (see below), it has been found that, surprisingly, treads or tread parts manufactured from such rubber mixtures can be expected to have advantageous wet grip properties (loss factor tan d at 0° C. as a wet grip indicator) and low rolling resistance (loss factor tan d at 70° C. as rolling resistance indicator), while still having unchanged good attrition resistance.

In a preferred execution, the rubber mixture contains silica and/or carbon black as filler.

In a further preferred execution, the polymer or oligomer of feature c) is a diene-based polymer or oligomer.

In a further preferred execution, the polymer or oligomer of feature c) has a glass transition temperature T_{g} of <−20° C., especially of <−30° C.

In a further preferred execution, the polymer or oligomer of feature c) is an average molar mass Mn (number-average molar mass by gel permeation chromatography) of 500 g/mol to 50 000 g/mol, especially of 1000 g/mol to 20 000 g/mol, more preferably of 3000 g/mol to 15 000 g/mol.

A further preferred execution is characterized in that the polymer or oligomer of feature c) has been functionalized with a silyl protecting group.

It is further preferable when the polymer or oligomer of feature c) is a polybutadiene functionalized with a filler-interactive functional group.

It is also preferable when the polymer or oligomer of feature c) and/or the polymer or oligomer of feature d) has been functionalized with a silyl protecting group of the formula (IV):

(R¹R²R³)Si— Formula IV

where
R¹, R², R³ are independently selected from the group of linear or branched alkoxy, cycloalkoxy, alkyl, cycloalkyl, aryl or hydroxyl groups, in each case having 1 to 20 carbon atoms, or hydrogen and
where the silyl protecting group of formula IV is attached directly or via a bridge to the polymer chain of the polymer or oligomer and
where the bridge is formed from a saturated or unsaturated hydrocarbyl radical that may contain heteroatoms, especially sulfur and/or nitrogen.

It is further preferable when the polymer or oligomer of feature d) has been functionalized with a silyl protecting group of the formula V:

—[Zₖ—Xₙ—R⁴—(CH₂)ₘ—Si(R⁵)ₚ]_{q} Formula V

where
Z is an aromatic or aliphatic group, optionally having one or more heteroatom(s),
X is a linker containing sulfur and/or oxygen and/or nitrogen and/or a carbonyl group,
R⁴ is one or more aliphatic groups having 1 to 18 carbon atoms and/or a connecting group to at least one heteroatom, especially to oxygen, nitrogen or sulfur,
R⁵ is a branched or unbranched alkoxy, aryloxy, alkyl or aryl group having 1 to 18 carbon atoms, hydrogen or a hydroxyl group, where at least one R⁵ is an alkoxy or aryloxy group having 1 to 18 carbon atoms, a hydrogen atom or a hydroxyl group, where R⁵ is the same or different within the molecule,
q is an integer ≥1,
k is 0 or 1,
n is an integer from 1 to 10,
m is an integer from 0 to 10 and
p is 1, 2 or 3.

It is further preferable when the polymer or oligomer of feature d) is a resin based on unsaturated aliphatic monomers, unsaturated aliphatic monomers, terpenes, rosin, unsaturated cycloaromatic monomers, unsaturated cycloaliphatic models, unsaturated fatty acids, methacrylates and/or vinylaromatic monomers.

It is further preferable when the polymer or oligomer of feature d) has a molar mass (Mn) of 200 g/mol to 150 000 g/mol, preferably of 200 g/mol to 50 000 g/mol, more preferably of 200 g/mol to 30 000 g/mol.

It is further preferable when the polymer or oligomer of feature c) and the polymer or oligomer of feature d) are present in a ratio of 1:50 to 50:1, especially of 1:10 to 10:1, preferably of 1:5 to 5:1, and more preferably of 1:3 to 3:1.

It is further preferable when the temperature differential ΔT_{g} ascertained between the glass transition temperature T_{g} of the polymer or oligomer of feature c) and the glass transition temperature T_{g} of the polymer or oligomer of feature d) is at least 5° C., especially at least 10° C.

It is further preferable when the rubber mixture contains at least one silane coupling agent. The silane coupling agent can also cause increased interaction of the filler with the polymers or oligomers.

The invention also relates to a pneumatic vehicle tire including at least one tire component consisting of rubber, especially a tread, that has been manufactured at least partly from a rubber mixture as claimed in any of claims 1 to 13. Such a tread has good wet grip properties, low rolling resistance and high attrition resistance. In particular, the trade-off that otherwise exists between these properties is resolved in a particularly favorable manner.

### BRIEF DESCRIPTION OF THE DRAWINGS

FIG. 1 is a table 2.1 showing a first test series-compositions of rubber mixtures.

FIG. 2 is a table 3.1 showing a second test series-compositions of rubber mixtures.

FIG. 3 is a table 4.1 showing a third test series-compositions of rubber mixtures.

FIG. 4 is a table 4.1 showing a fourth test series-compositions of rubber mixtures.

FIG. 5 is a table 5.1 showing a fifth test series-compositions of rubber mixtures.

### DETAILED DESCRIPTION

Further features, advantages and details of the invention will now be elucidated in detail with reference to test series which comprise working examples of the invention and are collated in tables.

The invention is concerned with a rubber mixture of particularly good suitability for manufacturing a tire component or a constituent of a tire component, especially of a tread or tread layer. In the course of the test series, rubber mixtures were produced and examined with regard to particular vulcanizate properties. Rubber mixtures executed according to the invention were compared with comparative rubber mixtures (reference rubber mixtures).

### Production of the Rubber Mixtures

The rubber mixtures were produced under the customary conditions in multiple stages in a laboratory mixer (300 mL, Brabender Mixer, CW Brabender GmbH & Co., South Hackensack, NJ, US). In the course of a first mixing stage (base mixing stage), all mixture constituents of the respective rubber mixture were mixed, except for at least some mixture constituents of the crosslinking system, especially with the exception of sulfur and accelerator. By mixing in the crosslinking system or the missing constituents of the crosslinking system, in a further mixing stage (finish mixing stage), the finished rubber mixture (finished mixture) was obtained. Table 1 contains the mixing parameters, i.e. the conditions under which the rubber mixtures were produced. The customary tolerance ranges of +/−3° C. are applicable to the temperatures.

TABLE 1
Mixing parameter
First mixing stage

| | |
|---|---|
| Rotor speed | 70 |
| [revolutions/minute] | |
| Starting temperature [° C.] | 130 |
| Final temperature [° C.] | 149 |

Second mixing stage

| | |
|---|---|
| Rotor speed | 55 |
| [revolutions/minute] | |
| Temperature [° C.] | 80 |

### Vulcanizate Tests

All rubber mixtures were used to produce standardized vulcanized test specimens (vulcanization conditions: time=20 min, temperature=160° C.), with which some typical vulcanizate properties were determined. The following vulcanizate tests were conducted:
Shore A hardness at room temperature (25° C.) by durometer according to DIN ISO 7619-1,
Loss factor tan d (tan δ) at 0° C. and at 70° C. from temperature-dependent dynamic-mechanical measurement by Eplexor according to DIN 53 513 (constant force, 10% compression, ±0.2% strain amplitude, frequency 10 Hz),
Attrition test at room temperature (25° C.) according to DIN ISO 4649

These vulcanizate properties permit conclusions to be drawn as to expected properties of a tread manufactured from such a rubber mixture or a radially outermost tread layer manufactured from such a rubber mixture that comes into contact with the road when driving.

Shore A hardness is especially a measure of stiffness of the vulcanizates.

Loss factor tan d at 0° C. serves as an indicator of wet grip of a tire. The higher the loss factor tan d at 0° C., the better the wet grip properties.

Loss factor tan d at 70° C. serves as an indicator of rolling resistance of a tire, with a lower loss factor tan d at 70° C. meaning lower rolling resistance.

In the attrition test, a correspondingly standardized test specimen is subjected to attrition, and the attritus (amount of material abraded) in mm³ is determined. The smaller the attritus value, the higher (better) the attrition resistance.

### Test Series Conducted

Multiple test series were conducted, in which the effects of specific mixture constituents on the vulcanizate properties mentioned were examined. These specific mixture constituents include resins that have been functionalized on a side group or terminally with a silyl protecting group ((R¹R²R³)Si—), and polybutadienes that have been terminally functionalized with a silyl protecting group. In connection with the test series, there will no longer be explicit reference hereinafter to the silyl protecting group, such that a “resin functionalized on a side group” is understood to mean a resin functionalized on a side group with a silyl protecting group, a “terminally functionalized resin” is understood to mean a resin terminally functionalized with a silyl protecting group, and “terminally functionalized liquid polybutadiene” is understood to mean a liquid polybutadiene terminally functionalized with a silyl protecting group.

By way of quantification of the functionalization, in some cases, the molar proportion functionalized with silyl protecting groups is reported hereinafter. The molar proportion relates here to the structural repeat unit which, in a known manner, is the smallest repeating unit within a polymer.

In the description that follows and in the tables, the amounts of the constituents of the rubber mixture are given in the unit phr (parts per hundred parts of rubber by weight) which is customary in rubber technology. The statements of amount are each based on the parts by mass of the base polymer, or on those of the base polymers in the case of polymer blends.

In the tables of the test series that state the compositions of the rubber mixtures, the corresponding current trade names (as at October 2019) are given in brackets for some mixture constituents. The test series include examples of inventive rubber mixtures E1 to E19, and reference rubber mixtures R¹ to R10.

### 1st Test Series—Variation of the Amount of Resin

Table 2.1 shows the compositions of the rubber mixtures of the 1st test series. In the 1st test series, the fundamental effects of terminally functionalized liquid polybutadiene (BR) were examined in combination with a terminally functionalized resin (corresponding statements of amounts shaded gray in table 2.1).

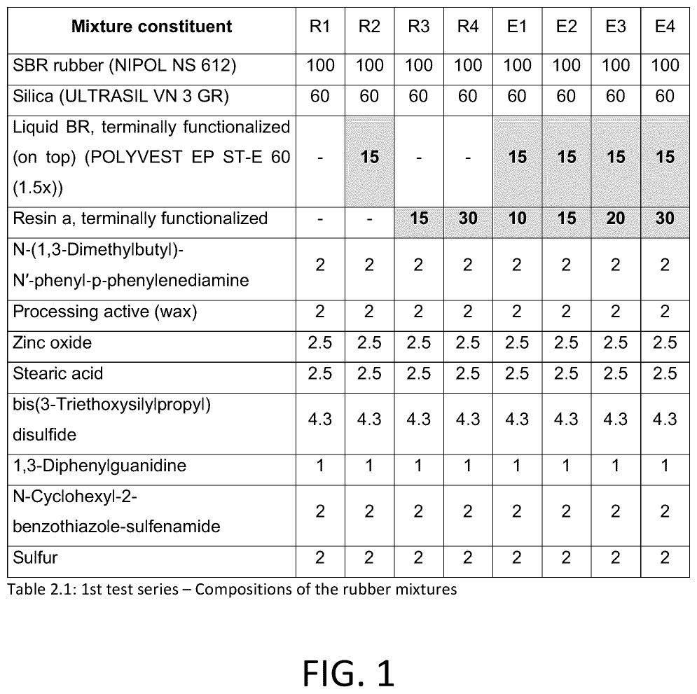

FIG. 1 shows the table 2.1.

### Table 2.1: 1st Test Series—Compositions of the Rubber Mixtures

All rubber mixtures in the 1st test series contain an SBR rubber as base polymer and a silica as filler.

The terminally functionalized liquid polybutadiene is not counted among the base polymers; it is present in addition to the base polymer (SBR rubber) (“on top”).

The terminally functionalized resin a is a resin based on α-methylstyrene, in which a molar proportion of 10% has been functionalized with silyl protecting groups. Resin a was synthesized according to example 1.2 of WO 2018/191187 A1 (paragraphs [0229] to [0231]) and has an average molar mass Mn (number-average molar mass by gel permeation chromatography) of 699 g/mol. Resin a was respectively present in rubber mixtures E1 to E4 in an amount of 10 phr, 15 phr, 20 phr and 30 phr.

Formula I shows the structural formula of resin a.

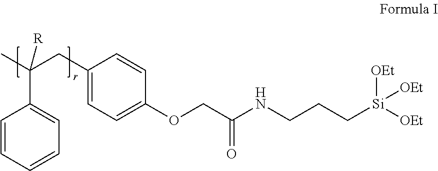

Additionally present are a silane (bis(3-triethoxysilylpropyl) disulfide), i.e. a silane coupling agent, and a sulfur or sulfur donor which is suitable for sulfur crosslinking. The further mixture constituents include two accelerators (N-cyclohexyl-2-benzothiazolesulfenamide and 1,3-diphenylguanidine), two activators (stearic acid, zinc oxide), a processing active and an aging stabilizer (N-(1,3-dimethylbutyl)-N′-phenyl-p-phenylenediamine).

Table 2.2 shows the results of the vulcanizate tests conducted for the rubber mixtures from table 2.1.

TABLE 2.2
1st test series-Vulcanizate tests

| Vulcanizate property | R1 | R2 | R3 | R4 | E1 | E2 | E3 | E4 |
|---|---|---|---|---|---|---|---|---|
| Shore A hardness | 70.1 | 66.2 | 65.4 | 66.9 | 67.6 | 67.4 | 68.2 | 66.7 |
| (T = 25° C.) | | | | | | | | |
| tan d (0° C.) | 0.203 | 0.144 | 0.298 | 0.347 | 0.210 | 0.233 | 0.265 | 0.331 |
| tan d (70° C.) | 0.112 | 0.078 | 0.122 | 0.161 | 0.087 | 0.082 | 0.088 | 0.091 |
| Attritus [mm³] | 100 | 98 | 126 | 142 | 104 | 109 | 111 | 126 |

As shown by a comparison of the vulcanizates made from R1 and R2, the sole use of terminally functionalized liquid polybutadiene (R2) leads to a smaller loss factor tan d (0° C.) (wet grip indicator) and to a smaller loss factor tan d (70° C.) (rolling resistance indicator). Consequently, a tread manufactured from reference rubber mixture R2—by comparison with a tread manufactured from reference rubber mixture R1—has poorer wet grip properties and lower (improved) rolling resistance. The attrition resistances of the vulcanizates made from R1 and R2 and hence of the corresponding treads as well are similar (100 vs. 98).

A comparison of the vulcanizates made from R1 and R3 shows that the sole use of terminally functionalized resin (R3) leads to a greater loss factor tan d (0° C.) (wet grip indicator) and to a greater loss factor tan d (70° C.) (rolling resistance indicator). A tread manufactured from reference rubber mixture R3—by comparison with a tread manufactured from reference rubber mixture R1—therefore has better wet grip properties and greater (worsened) rolling resistance. The attrition resistance of the vulcanizate made from R3 is much poorer than the attrition resistance of the vulcanizate made from R1 (126 vs. 100).

As shown by the vulcanizate made from R4 by comparison with the vulcanizates made from R3 and R1, use of greater amounts of terminally functionalized resin (R4) can further increase the loss factor tan d (0° C.) (wet grip indicator), but the loss factor tan d (70° C.) (rolling resistance indicator) is also distinctly increased. A tread manufactured from reference rubber mixture R4 therefore has very good wet grip properties, but very high (distinctly worsened) rolling resistance. Moreover, the vulcanizate made from R4 shows a very high and therefore poor attrition value (142 vs. 126 or 100).

The vulcanizates made from the inventive rubber mixtures E1 to E4 have a higher loss factor tan d (0° C.) (wet grip indicator) than the vulcanizates made from the reference rubber mixtures R1 and R2, and a lower loss factor tan d (70° C.) (rolling resistance indicator) than the vulcanizates of reference rubber mixtures R1, R3, R4. A tread manufactured from the inventive rubber mixtures E1 to E4—by comparison with a tread manufactured from reference rubber mixture R1, R2—therefore has better wet grip properties and-by comparison with a tread manufactured from reference rubber mixture R1, R3, R4—distinctly lower (improved) rolling resistance. The attrition resistance of the vulcanizates made from E1 to E4 is in some cases distinctly improved over the attrition resistance of the vulcanizates made from R3 and R4.

It follows from the 1st test series that the vulcanizates made from the inventive rubber mixtures E1 to E4 (containing terminally functionalized liquid polybutadiene in combination with a terminally functionalized resin) give improved wet grip properties and an improved rolling resistance value without losing out with regard to attrition resistance.

### 2nd Test Series—Linker of the Resin

In a 2nd test series, the effects of a further terminally functionalized resin (resin b) that differs from the terminally functionalized resin a used in the 1st test series were examined.

### Table 3.1: 2nd Test Series—Compositions of the Rubber Mixtures

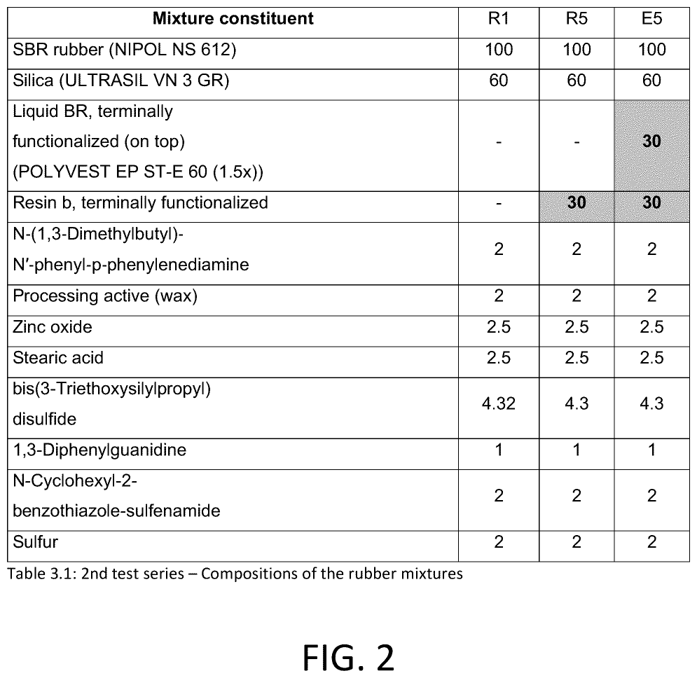

FIG. 2 shows the table 3.1.

The terminally functionalized resin b is a resin based on α-methylstyrene, in which a molar proportion of 10% has been functionalized with silyl protecting groups. Resin b was synthesized according to example 1.9 of WO 2018/191187 A1 (paragraphs [0248] to [0249]) and has an average molar mass Mn of 775 g/mol.

Formula II shows the structural formula of resin b.

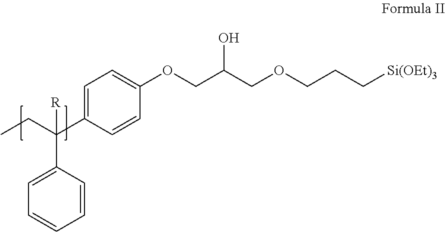

TABLE 3.2
2nd test series - Vulcanizate tests

| Vulcanizate property | R1 | R5 | E5 |
|---|---|---|---|
| Shore A hardness (T = 25° C.) | 70.1 | 62.9 | 66.7 |
| tan d (0° C.) | 0.203 | 0.330 | 0.346 |
| tan d (70° C.) | 0.112 | 0.117 | 0.098 |
| Attritus [mm³] | 100 | 148 | 117 |

The vulcanizate made from E5, compared respectively to the vulcanizate made from R1 and R5, has a greater loss factor tan d (0° C.) (wet grip indicator) and a smaller loss factor tan d (70° C.) (rolling resistance indicator). A tread manufactured from inventive rubber mixture E5—by comparison with a tread manufactured from reference rubber mixture R1 or R5—therefore has better wet grip properties and lower (improved) rolling resistance. Attrition resistance is distinctly improved over the vulcanizate made from R5.

It follows from the 2nd test series that the advantageous vulcanizate properties are achievable irrespective of the structure of the linker of the resin.

### 3rd Test Series—Basis of the Resin and Position of the Functionalization of the Resin

In a 3rd test series, it was shown that the advantageous effects are also achievable with resins having side group functionalization, and with resins that have a different basis from the resins in the 1st and 2nd test series (based on α-methylstyrene in the 1st and 2nd test series). Table 4.1 contains the corresponding compositions of the rubber mixtures.

### Table 4.1: 3rd Test Series—Compositions of the Rubber Mixtures

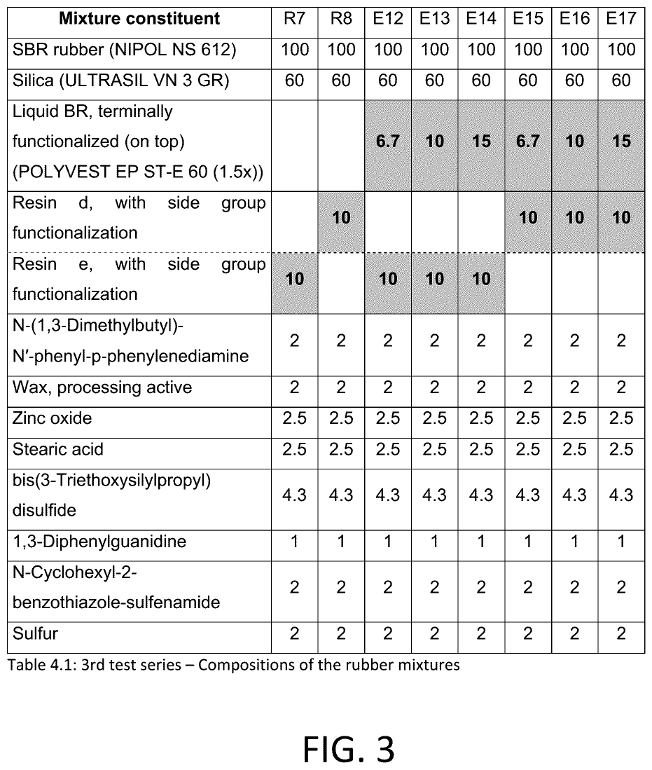

FIG. 3 shows the table 4.1 third test series.

Resin d with side group functionalization is a resin based on α-methylstyrene, in which a molar proportion of 10% has been functionalized with silyl protecting groups. Resin d was synthesized according to example 1.4 of WO 2018/191187 A1 (paragraphs [0235] to [0237]) and has an average molar mass Mn of 534 g/mol.

Resin e with side group functionalization is a resin based on methyl acrylate, in which a molar proportion of 10% has been functionalized with silyl protecting groups. Resin e was synthesized according to example 1.8 of WO 2018/191187 A1 (paragraphs [0246] and [0247]) and has an average molar mass Mn of 876 g/mol.

TABLE 5.2
3rd test series-Vulcanizate tests

| Vulcanizate property | R7 | R8 | E12 | E13 | E14 | E15 | E16 | E17 |
|---|---|---|---|---|---|---|---|---|
| Shore A hardness (T = | 70.9 | 70 | 70.2 | 70.2 | 70.8 | 69 | 67.6 | 67.2 |
| 25° C.) | | | | | | | | |
| tan d (0° C.) | 0.233 | 0.249 | 0.247 | 0.228 | 0.231 | 0.244 | 0.248 | 0.276 |
| tan d (70° C.) | 0.093 | 0.116 | 0.097 | 0.088 | 0.088 | 0.104 | 0.098 | 0.112 |
| Attritus [mm³] | 108 | 114 | 89 | 98 | 96 | 88 | 84 | 83 |

The vulcanizates made from E12 to E14 (corresponding rubber mixtures contain terminally functionalized liquid polybutadiene and methacrylate-based resin with side group functionalization), by comparison with the vulcanizate made from R7 (corresponding rubber mixture contains “only” methacrylate-based resin with side group functionalization), show a distinct improvement in attritus (89/98/96 vs. 108), with maintenance of loss factor tan d (0° C.) (wet grip indicator) and of loss factor tan d (70° C.) (rolling resistance indicator).

The vulcanizates made from E15 to E17 (corresponding rubber mixtures contain terminally functionalized liquid polybutadiene and α-methylstyrene-based resin with side group functionalization), by comparison with the vulcanizate made from R8 (corresponding rubber mixture contains “only” α-methylstyrene-based resin with side group functionalization), show a smaller tan d) (70° (i.e. reduced rolling resistance for the tread) and a distinct improvement in attritus (88/84/83 vs 114).

It follows from the 3rd test series that the advantageous vulcanizate properties, especially attrition resistance, are achievable irrespective of the position (side group, end group) of the functionalization of the resin and irrespective of the basis of the resin.

### 4th Test Series—Amount of Polybutadiene, Type of Polybutadiene, Resins With Different Molar Mass and Different Positions of Functionalization

In a 4th test series, the effects of different amounts of terminally functionalized liquid polybutadiene were examined, with examination both of the already mentioned POLYVEST EP ST-E 60 and of “Ricon 603”. Ricon 603 differs from POLYVEST EP ST-E 60 in its glass transition temperature T_{g}, its vinyl content and in its ratio of cis to trans-isomers (cis/trans ratio). The terminally functionalized resin b already mentioned (Mn 775 g/mol) and a side group-functionalized resin c were used.

### Table 4.1: 4th Test Series—Compositions of the Rubber Mixtures

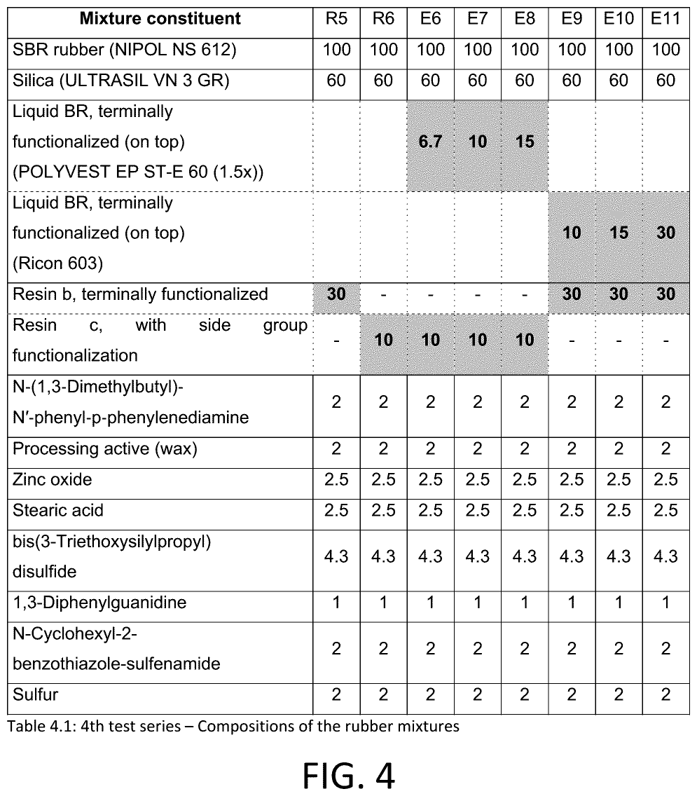

FIG. 4 shows the table 4.1 fourth test series.

The side group-functionalized resin c was synthesized by free-radical copolymerization according to example 1.5 of WO 2018/191187 A1 (paragraphs [0238] to [0241]) and has an average molar mass Mn of 5320 g/mol.

Formula III shows the structural formula of resin c.

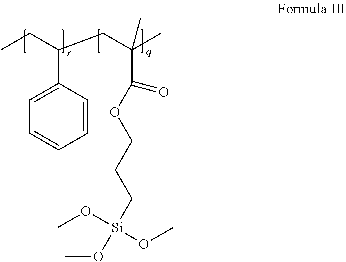

TABLE 4.2
4th test series—Vulcanizate tests

| Vulcanizate property | R5 | R6 | E6 | E7 | E8 | E9 | E10 | E11 |
|---|---|---|---|---|---|---|---|---|
| Shore A hardness | 62.9 | 66.2 | 67.6 | 67.4 | 68.2 | 63.9 | 65 | 66.1 |
| (T = 25° C.) | | | | | | | | |
| tan d (0° C.) | 0.330 | 0.252 | 0.234 | 0.217 | 0.203 | 0.340 | 0.343 | 0.378 |
| tan d (70° C.) | 0.117 | 0.119 | 0.099 | 0.094 | 0.085 | 0.084 | 0.075 | 0.070 |
| Attritus [mm³] | 148 | 123 | 112 | 108 | 103 | 107 | 109 | 135 |

As shown by a comparison of the vulcanizates manufactured from resin b-containing rubber mixtures R5, E9, E10, E11, the advantageous effects described are also achievable with Ricon 603. For instance, the vulcanizates made from rubber mixtures E9, E10, E11—in each case by comparison with the vulcanizate made from reference rubber mixture R5—have a greater loss factor tan d (0° C.) (wet grip indicator) and a lower loss factor tan d (70° C.) (rolling resistance indicator); therefore, they give treads with better wet grip and rolling resistance properties. In particular, the vulcanizates made from rubber mixtures E9, E10, E11—by comparison with the vulcanizate made from reference rubber mixture R5—each have a much greater difference between their value for tan d (0° C.) and their value for tan d (70° C.), which suggests a particularly favorable solution to the trade-off that exists between wet grip properties and rolling resistance. Surprisingly, the vulcanizates made from rubber mixtures E9, E10, E11 are also better in terms of their attrition resistance than the vulcanizate made from reference rubber mixture R5 (107, 109, 135 vs. 148). Small amounts of Ricon 603 (E9, E10) were very favorable for attrition resistance.

A comparison of the vulcanizates manufactured from resin c-containing rubber mixtures R6, E6, E7, E8 shows the effect of POLYVEST EP ST-E 60. The vulcanizates made from rubber mixtures E6, E7, E8—each by comparison with the vulcanizate made from rubber mixture R6—have smaller values for loss factor tan d (0° C.) (wet grip indicator), smaller values for loss factor tan d (70° C.) (rolling resistance indicator), and smaller values for attrition. Rubber mixtures E6, E7, E8 therefore give treads that are more attrition-resistant and have improved rolling resistance.

It follows from the 4th test series that the advantageous vulcanizate properties are achievable irrespective of glass transition temperature T_{g}, vinyl content and the ratio of cis to trans isomers (cis/trans ratio) of the polybutadienes. It has also been shown that the position (end group/side group) of the functionalization of the resins and the molar mass thereof has no significant effect, if any.

### 5th Test Series—Diene Rubbers and Amount of Filler

In this test series, rubber mixtures that contained both SBR rubber and natural rubber (SBR/NR blends), and higher amounts of filler compared to the rubber mixtures to date, were tested.

### Table 5.1: 5th Test Series—Compositions of the Rubber Mixtures

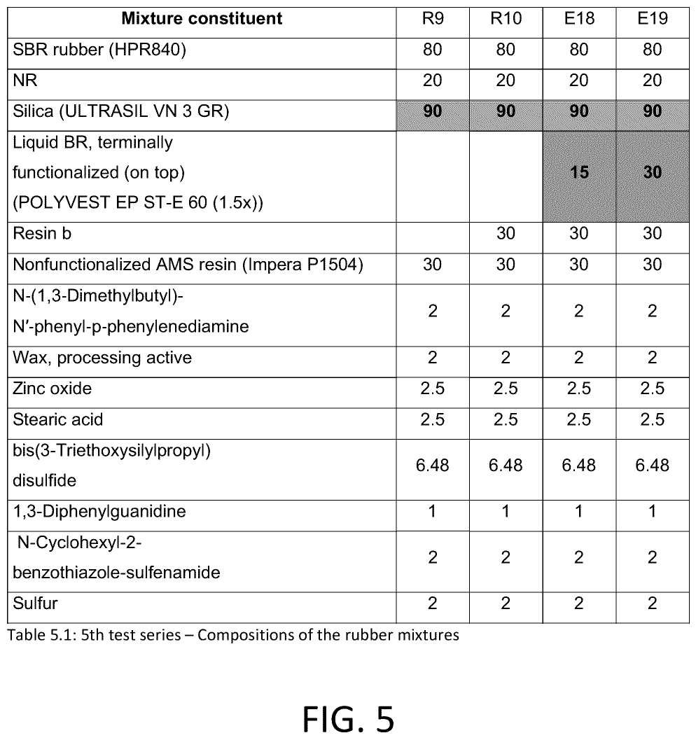

FIG. 5 shows the table 5.1 fifth test series.

The SBR rubber used in the 5th test series is HPR 840, which is a functionalized styrene-butadiene copolymer, the preparation of which is described, for example, in EP 2 703 416 A1. HPR 840 is functionalized at a chain end with a silyl protecting group containing amino groups and/or one containing ammonium groups. Such functionalizations can be obtained by reaction of an SBR rubber with an alkoxysilyl compound containing an amino group, having protecting groups of the amino group. For example, it is possible to use N,N-bis(trimethylsilyl)aminopropylmethyldiethoxysilane. Further possible substances for such a functionalization are described in EP 2 703 416 A1. After deprotection (elimination of the protecting group), HPR 840 is obtained.

HPR 840 is functionalized at the other chain end with an amino group. The amino groups may be primary, secondary or tertiary amino groups, which may also be in cyclic form. The functionalization can be achieved by adding lithium amides in the polymerization, as described in EP 2 703 416 A1, or producing the amides in situ by addition of n-butyllithium and amines, e.g. cyclic amines such as piperidine or piperazines, in the polymerization.

The amino group at the other chain end is preferably a cyclic amino group. For this purpose, for example, piperidine may be added in combination with n-butyllithium in the polymerization.

TABLE 5.2
5th test series - Vulcanizate tests

| Vulcanizate property | R9 | R10 | E18 | E19 |
|---|---|---|---|---|
| Shore A hardness (T = 25° C.) | 70.8 | 60.8 | 60.5 | 59.2 |
| tan d (0° C.) | 0.508 | 0.603 | 0.66 | 0.567 |
| tan d (70° C.) | 0.145 | 0.159 | 0.128 | 0.099 |
| Attritus [mm³] | 106 | 127 | 100 | 111 |

The vulcanizates made from E18 and E19, by comparison with the vulcanizates made from R9 and R10, tend to have a higher loss factor tan d (0° C.) (wet grip indicator) and a much lower loss factor tan d (70° C.) (rolling resistance indicator). The rolling resistance of a tread manufactured from E18 or E19 is therefore much lower compared to a tread manufactured from R9 or R10. Moreover, the wet grip of a tread manufactured from E18 or E19 tends to be improved over a tread manufactured from R9 or R10. Attrition resistance tends to be improved.

In the 5th test series, it was shown that the effects are not restricted to rubber mixtures containing exclusively SBR rubber and can also be achieved with higher amounts of filler.

### Conclusion

Table 6 shows a summary of test series 1 to 5 that have been conducted.

TABLE 6
Summary of the test series

| | TS1 | TS2 | TS3 | TS3 | TS4 | TS4 | TS5 |
|---|---|---|---|---|---|---|---|
| Diene rubber | SBR | SBR | SBR | SBR | SBR | SBR | SBR/NR |
| Resin | a | b | d | e | b | c | b |
| Functionalization | End | End | Side | Side | End | Side | End |
| Resin basis | α-Methyl- | α-Methyl- | α-Methyl- | Meth- | α-Methyl- | α-Methyl- | α-Methyl- |
| | styrene | styrene | styrene | acrylate | styrene | styrene | styrene |
| Average molar | 699 | 775 | 534 | 876 | 775 | 5320 | 775 |
| mass Mn [g/mol] | | | | | | | |
| Formula | Formula I | Formula II | * | * | Formula II | Formula III | Formula II |
| Polybutadiene, | POLYV. | POLYV. | POLYV. | POLYV. | Ricon | POLYV. | POLYV. |
| terminally | EP ST- | EP ST- | EP ST- | EP ST- | 603 | EP ST- | EP ST- |
| functionalized | E 60 | E 60 | E 60 | E 60 | | E 60 | E 60 |

* see WO 2018/191187 A1

What follows in particular from the test series conducted is that rubber mixtures comprising diene rubbers containing a resin functionalized on a side group or terminally functionalized with a silyl protecting group, in combination with a liquid polybutadiene terminally functionalized with a silyl protecting group, give vulcanizates having advantageous wet grip properties, low rolling resistance and at least essentially unchanged attrition resistance.

The invention is not limited to the specific working examples described.

What follows hereinafter is a recitation of a multitude of alternative mixture constituents and corresponding elucidation of the mixture constituents for rubber mixtures E1 to E19 that have been set out in the test series, i.e. for the working examples of the invention.

### Diene Rubber Having an Average Molar Mass Mn of More Than 150 000 g/mol

The rubber mixture according to the invention is sulfur-crosslinkable and contains at least one diene rubber.

Diene rubbers are rubbers which are formed by polymerization or copolymerization of dienes and/or cycloalkenes and thus have C═C double bonds either in the main chain or in the side groups.

The diene rubber(s) is/are preferably selected from the group of natural polyisoprene, synthetic polyisoprene, epoxidized polyisoprene, butadiene rubber, butadiene-isoprene rubber, solution-polymerized styrene-butadiene rubber, emulsion-polymerized styrene-butadiene rubber, styrene-isoprene rubber, liquid rubber having a molar mass Mw of greater than 20 000 g/mol, halobutyl rubber, polynorbornene, isoprene-isobutylene copolymer, ethylene-propylene-diene rubber, nitrile rubber, chloroprene rubber, acrylate rubber, fluoro rubber, silicone rubber, polysulfide rubber, epichlorohydrin rubber, styrene-isoprene-butadiene terpolymer, hydrogenated acrylonitrile-butadiene rubber, hydrogenated styrene-butadiene rubber, butyl rubber (IIR) and halobutyl rubber.

If the rubber mixture is intended for a tread of a vehicle tire, the diene rubber(s) is/are preferably selected from the group of natural polyisoprene (NR), synthetic polyisoprene (IR), butadiene rubber (BR), solution-polymerized styrene-butadiene rubber (SSBR) and emulsion-polymerized styrene-butadiene rubber (ESBR).

In a preferred execution, the rubber mixture contains at least one natural polyisoprene in an amount of 2 phr to 100 phr, especially of 5 phr to 30 phr, more preferably 5 phr to 20 phr. In this way, particularly good processibility of the rubber mixture is achieved. Natural polyisoprene is understood to mean rubber that is obtained by harvesting from sources such as rubber trees (Hevea brasiliensis) or non-rubber tree sources (for example guayule or dandelion (e.g. Taraxacum koksaghyz)). Natural polyisoprene (NR) is understood to mean nonsynthetic polyisoprene.

In a further advantageous execution, the rubber mixture contains at least one polybutadiene (butadiene rubber), preferably in an amount of 2 phr to 100 phr, especially of 5 phr to 50 phr, more preferably of 10 phr to 25 phr. In this way, particularly good attrition properties and tensile properties of the rubber mixture and good processibility coupled with low hysteresis loss are achieved.

In a further particularly advantageous embodiment, the rubber mixture contains at least one styrene-butadiene rubber (SBR) in an amount of 2 phr to 100 phr, especially of 25 phr to 80 phr, preferably of 65 phr to 85 phr. In this way, good processibility coupled with low hysteresis loss, and good attrition properties and tensile properties of the rubber mixture are likewise achieved. The SBR is preferably an SSBR, which results in optimized properties.

In a further particularly advantageous execution, the rubber mixture contains a polymer blend of the stated rubbers NR, BR and SBR, preferably SSBR, preferably in the respectively specified amounts in all possible combinations.

In a further particularly advantageous execution, the rubber mixture contains at least one natural and/or synthetic polyisoprene in an amount of 5 phr to 30 phr, at least one styrene-butadiene rubber in an amount of 25 phr to 80 phr, and at least one butadiene rubber in an amount of 5 phr to 50 phr.

The natural and/or synthetic polyisoprene may in each case be either cis-1,4-polyisoprene or 3,4-polyisoprene. Preference is given to the use of cis-1,4-polyisoprene with a cis-1,4 content of >90% by weight. The polyisoprene can be obtained by stereospecific polymerization in solution with Ziegler-Natta catalysts or using finely divided lithium alkyls. Natural rubber (NR) is cis-1,4-polyisoprene where the cis-1,4 content is greater than 99% by weight.

A mixture of one or more natural polyisoprenes with one or more synthetic polyisoprenes is further also conceivable.

If the rubber mixture contains butadiene rubber (=BR, polybutadiene), this may be of the types known to those skilled in the art. These include what are called the high-cis and low-cis types, with polybutadiene having a cis content of not less than 90% by weight being referred to as the high-cis type and polybutadiene having a cis content of less than 90% by weight being referred to as the low-cis type. An example of a low-cis polybutadiene is Li-BR (lithium-catalyzed butadiene rubber) having a cis content of 20% by weight to 50% by weight. A high-cis BR achieves particularly good abrasion properties and low hysteresis of the rubber mixture.

The polybutadiene(s) used may be end group-modified with modifications and functionalizations and/or be functionalized along the polymer chains. The modification may be selected from modifications with hydroxyl groups and/or ethoxy groups and/or epoxy groups and/or siloxane groups and/or amino groups and/or aminosiloxane and/or carboxyl groups and/or phthalocyanine groups and/or silane-sulfide groups. However, other modifications known to those skilled in the art, also referred to as functionalizations, are also useful. Metal atoms may be a constituent of such functionalizations.

In the case where at least one styrene-butadiene rubber is present in the rubber mixture, this may be selected from solution-polymerized styrene-butadiene rubber (SSBR) and emulsion-polymerized styrene-butadiene rubber (ESBR), and it is also possible to use a mixture of at least one SSBR and at least one ESBR. The terms “styrene-butadiene rubber” and “styrene-butadiene copolymer” are used synonymously in the context of the present invention.

The styrene-butadiene copolymer used may be end group-modified and/or functionalized along the polymer chains with the modifications and functionalizations mentioned above for the polybutadiene.

The rubbers may be used as pure rubbers or in oil-extended form.

### Filler

At least one arbitrary filler is present. In particular, carbon blacks, silicas, aluminosilicates, kaolin, chalk, starch, magnesium oxide, titanium dioxide or rubber gels, and also fibers (for example aramid fibers, glass fibers, carbon fibers, cellulose fibers), may be present in the rubber mixture, and the fillers may be used in combination. Fillers provided may also be carbon nanotubes (CNT), including discrete CNTs, so-called hollow carbon fibres (HCF) and modified CNTs containing one or more functional groups, such as hydroxyl, carboxyl and carbonyl groups, graphite, graphene, and “carbon-silica dual-phase fillers”.

There may accordingly also be two or more silicas in the mixture. The silicas may be the silicas that are known to the person skilled in the art and are suitable as filler for tire rubber mixtures. However, particular preference is given to using a finely divided, precipitated silica which has a nitrogen surface area (BET surface area) (in accordance with DIN ISO 9277 and DIN 66132) of 35 m²/g to 400 m²/g, preferably 35 m²/g to 350 m²/g, more preferably 85 m²/g to 320 m²/g and most preferably 120 m²/g to 235 m²/g, and a CTAB surface area (in accordance with ASTM D 3765) of 30 m²/g to 400 m²/g, preferably 30 m²/g to 330 m²/g, more preferably 80 m²/g to 300 m²/g and most preferably 115 m²/g to 200 m²/g.

Silicas used may thus, for example, be not only those of the type Ultrasil® VN3 (trade name) from Evonik but also silicas having a comparatively low BET surface area (such as for example Zeosil® 1115 or Zeosil® 1085 from Solvay), and also highly dispersible silicas, called HD silicas (for example Zeosil® 1165 MP from Solvay). The silica preferably has a CTAB number of more than 130 m²/g.

The amount of the at least one silica is especially 5 phr to 300 phr, preferably 10 phr to 200 phr, more preferably 20 phr to 180 phr. In the case of different silicas, the indicated amounts mean the total amount of silicas present.

In one embodiment, the carbon black has/carbon blacks have an iodine number to ASTM D 1510 (iodine adsorption number) of 30 g/kg and 250 g/kg, especially of 30 g/kg to 180 g/kg, preferably 40 g/kg to 180 g/kg, more preferably of 40 kg/g to 130 kg/g, and a DBP number to ASTM D 2414 of 80 ml/100 g to 200 ml/100 g, especially of 100 ml/100 g to 200 ml/100 g, preferably of 115 ml/100 g to 200 ml/100 g. The DBP number in accordance with ASTM D 2414 determines the specific absorption volume of a carbon black or a light-colored filler by means of dibutyl phthalate.

The use of such a type of carbon black in the rubber mixture, in particular for vehicle tires, ensures the best possible compromise between attrition resistance and heat buildup, which in turn influences the ecologically relevant rolling resistance. It is preferable when a single carbon black type is used, but it is also possible to use various different carbon black types in combination. Carbon black(s) is/are present in the total amount of up to 250 phr.

### Polymer or Oligomer Having an Average Molar Mass Mn of Less Than 150 000 g/mol, Functionalized With a Filler-Interactive Functional Group and Having a Glass Transition Temperature T_{g}<−15° C.

Rather than the polybutadiene (PR) terminally functionalized with a silyl protecting group which is used in the working examples, it is possible to use at least one arbitrary polymer or oligomer having an average molar mass Mn (number-average molar mass by gel permeation chromatography) of less than 150 000 g/mol, functionalized at any site with a filler-interactive functional group and having a glass transition temperature T_{g}<−15° C.

What is meant by “filler-interactive” is that the polymer or oligomer interacts with the surface of the filler via van der Waals, dipole-dipole or electrostatic interactions or via covalent or noncovalent bonds, for example hydrogen bonds.

The glass transition temperature T_{g} is preferably <−20° C., more preferably <−30° C. It is further preferable when the average molar mass Mn is 500 g/mol to 50 000 g/mol, especially from 1000 g/mol to 20 000 g/mol, more preferably from 3000 g/mol to 15 000 g/mol.

Functionalization can be effected with hydroxyl groups and/or ethoxy groups and/or epoxy groups and/or siloxane groups and/or amino groups and/or aminosiloxane and/or carboxyl groups and/or acid anhydrides and/or phthalocyanine groups and/or silane-sulfide groups. However, other modifications (functionalizations) known to the person skilled in the art are also useful. Metal atoms may be a constituent of such functionalizations.

It is also favorable when the polymer or oligomer mentioned contains one or more silicon atoms. It has preferably been functionalized with a silyl protecting group of the formula IV:

(R¹R²R³)Si— Formula IV

R¹, R², R³: The R¹, R², R³ radicals are independently selected from the group of linear or branched alkoxy, cycloalkoxy, alkyl, cycloalkyl, aryl or hydroxyl groups, each having 1 to 20 carbon atoms, or hydrogen.

The silyl protecting group of formula IV may be attached directly or via a bridge to the polymer chain of the polymer or oligomer. The bridge may be formed from a saturated or unsaturated hydrocarbyl radical that may contain heteroatoms, especially sulfur and/or nitrogen.

The functionalization may be one of those described above and may have a degree of functionalization of, for example, 0.0006 mol % to 100 mol % of the monomers, especially of 0.05 mol % to 70 mol % of the monomers, preferably 0.1 mol % to 50 mol % of the monomers, where the functionalization can be effected at the end or within the chain.

The polymer or oligomer functionalized with a filler-interactive group may especially be present in amounts of 5 phr to 200 phr, preferably of 10 phr to 150 phr, more preferably of 10 phr to 100 phr.

In addition, unfunctionalized polymers or oligomers or a combination of functionalized and unfunctionalized polymers or oligomers may be mixed into the mixture. The total amount of polymers or oligomers mixed in is 2 phr to 200 phr, especially from 5 phr to 150 phr, preferably from 10 phr to 100 phr. In addition, it is possible to use combinations of functionalized polymers and oligomers. In particular, it is possible to use combinations of end group-and side group-functionalized oligomers or polymers.

Useful polymers or oligomers here include all polymers with Tg<−15° C., and hence also polyolefins such as poly(vinylidene chloride), polyethylene, poly(vinylidene fluoride), polyacrylate, poly(decyl methacrylate), poly(dodecyl methacrylate), poly(isodecyl methacrylate), poly(octyl methacrylate) polypropylene, poly(1-butene), poly(1-octene), poly(1-pentene), poly(isobutene), poly(1-methyl-1-butenylene), poly(caprolactone), poly(1,4-butane sebacate), poly(ethylene adipate), poly(3-hexoxypropylene oxide), poly(dipropyl fumarate), poly(ethylene glycol), poly(propylene glycol), poly(trimethylene glycol), polyacetal, poly(vinyl ether), poly(vinyl ethyl ketone), poly(butyl vinyl thioether), and also the abovementioned rubbers consisting of polyisoprene, epoxidized polyisoprene, butadiene rubber, butadiene-isoprene rubber, styrene-butadiene rubber, styrene-isoprene rubber, halobutyl rubber, polynorbornene, isoprene-isobutylene copolymer, ethylene-propylene-diene rubber, nitrile rubber, chloroprene rubber, acrylate rubber, polycyclopentene rubber, fluoro rubber, silicone rubber, polysulfide rubber, epichlorohydrin rubber, styrene-isoprene-butadiene terpolymer, hydrogenated acrylonitrile-butadiene rubber, hydrogenated styrene-butadiene rubber, farnesene and liquid rubbers having a molar mass Mw of greater than 20 000 g/mol.

The polymer(s) or oligomer(s) is/are preferably selected from the group of polyethylene, polypropylene, natural polyisoprene, synthetic polyisoprene, epoxidized polyisoprene, butadiene rubber, butadiene-isoprene rubber, solution-polymerized styrene-butadiene rubber, emulsion-polymerized styrene-butadiene rubber, styrene-isoprene rubber, liquid rubbers having a molar mass Mw of greater than 20 000 g/mol, halobutyl rubber, polynorbornene, isoprene-isobutylene copolymer, ethylene-propylene-diene rubber, nitrile rubber, chloroprene rubber, acrylate rubber, fluoro rubber, silicone rubber, polysulfide rubber, epichlorohydrin rubber, styrene-isoprene-butadiene terpolymer, hydrogenated acrylonitrile-butadiene rubber, hydrogenated styrene-butadiene rubber and farnesene.

In addition, it is possible to use combinations of the aforementioned oligomers or polymers.

### Polymer or Oligomer Having an Average Molar Mass Mn of Less Than 150 000 g/mol, Functionalized With a Filler-Interactive Functional Group and Having a Glass Transition Temperature T_{g}>−15° C.

The resin terminally functionalized with a silyl protecting group which is used in the working examples is any polymer or oligomer having a glass transition temperature T_{g}>−15° C., especially >−10° C., having functionalization at any site with a filler-interactive functional group.

The molar mass (Mn) is especially 200 g/mol to 150 000 g/mol, preferably 200 g/mol to 50 000 g/mol, more preferably 200 g/mol to 30 000 g/mol. The glass transition temperature (Tg) is especially below 200° C., preferably below 180° C. and more preferably below 160° C.

In addition, it is possible to use combinations of oligomers or polymers having different molar masses.

Functionalization can be effected with hydroxyl groups and/or ethoxy groups and/or epoxy groups and/or siloxane groups and/or amino groups and/or aminosiloxane and/or carboxyl groups and/or acid anhydrides and/or phthalocyanine groups and/or silane-sulfide groups. However, other modifications (functionalizations) known to the person skilled in the art are also useful. Metal atoms may be a constituent of such functionalizations.

This polymer or oligomer has preferably likewise been functionalized with the silyl protecting group of the formula IV already mentioned, as described in WO 2015/153055 for dicyclopentadiene (DCPD). Alternatively, it is preferable when it has been functionalized with a silyl protecting group of formula V:

—[Zₖ—Xₙ—R⁴—(CH₂)ₘ—Si(R⁵)ₚ]_{q} Formula V

In formula V,
Z is an aromatic or aliphatic group, optionally having one or more heteroatom(s),
X is a linker containing sulfur and/or oxygen and/or nitrogen and/or a carbonyl group,
R⁴ is one or more aliphatic group(s) having 1 to 18 carbon atoms and/or a connecting group to at least one heteroatom, especially to oxygen, nitrogen or sulfur,
R⁵ is a branched or unbranched alkoxy, aryloxy, alkyl or aryl group having 1 to 18 carbon atoms, hydrogen or a hydroxyl group, where at least one R⁵ is an alkoxy or aryloxy group having 1 to 18 carbon atoms, a hydrogen atom or a hydroxyl group, where R⁵ may be the same or different within the molecule,
q is an integer ≥1,
k is 0 or 1,
n is an integer from 1 to 10,
m is an integer from 0 to 10 and
p is 1, 2 or 3.

The functionalization may be one of those described above and may have a degree of functionalization of, for example, 0.0006 mol % to 100 mol % of the monomers, 0.05 mol % to 70 mol % of the monomers, preferably 0.1 mol % to 50 mol % of the monomers, where the functionalization can be effected at the end or within the chain. The polymer or oligomer functionalized with a filler-interactive group may be used in amounts of 5 phr to 200 phr, especially of 10 phr to 150 phr, more preferably of 10 phr to 100 phr.

In addition, unfunctionalized polymers or oligomers may be mixed into the mixture, or a combination of functionalized and unfunctionalized polymers or oligomers may be mixed into the mixture. The total amount of polymers or oligomers mixed in is 2 phr to 200 phr, 5 to 150 phr or 10 to 100 phr.

The oligomer or polymer used with preference is especially based on the polymerization or copolymerization of two or more unsaturated aliphatic monomers, unsaturated aromatic monomers, terpenes, terpene-phenols, rosin acids, rosin, unsaturated cycloaromatic monomers, unsaturated cycloaliphatic monomers, unsaturated fatty acids, methacrylates and/or vinylaromatic monomers or a mixture of aliphatic and aromatic monomers. The aliphatic monomer may be selected from C₅ 1,3-pentadiene, benzofuran (coumarone), indene, indane, as described in WO2018118855A1, and dicyclopentadiene. The aromatic monomers and/or vinylaromatic monomers may, for example, be selected from styrene, vinyltoluene, alpha-methylstyrene and diisopropylbenzene.

The monomers of the terpenes may be mono-and/or bicyclic terpenes.

The oligomer or polymer may also be selected from the group of polyolefins, polyesters, polyethers, polythioethers, polyketones, polyphthalates, polyterephthalates, polyacrylamides, polylactates, polycarvonates, polyacetates, polyketones, polymethacrylates, polyacrylates, polymethacrylonitriles and polyacrylonitriles, polyamides as oligomers or polymers.

These especially include alpha-methylstyrene, styrene, vinyltoluene, diisopropylbenzene, 1,3-pentadiene, benzofuran (coumarone), indene, indane, dicyclopentadiene, terpenes, ethyl-vinyl acetate, ethyl-butyl acetate and styrene block copolymers.

In addition, it is possible to use combinations of functionalized polymers or oligomers. In particular, it is possible to use combinations of end group-and side group-functionalized oligomers or polymers.

### Silane

Silanes are optionally used in the mixture of the invention, especially when the selection of the polymers or oligomers mentioned with Tg<−15° C. or Tg>−15° C. does not enable optimal crosslinking to the diene rubber and hence optimal attachment of the diene rubber to the filler.

There is preferably a coupling agent in the form of silane or an organosilicon compound in the rubber mixture. It is possible to use a single silane or various silanes in combination with one another. Useful silanes are mentioned, for example, in WO 2018/191187 A1, paragraph [0094].

Silane coupling reagents may be used as adhesion promoters for inorganic materials, for example glass beads, glass shards, glass surfaces, glass fibers, for oxidic fillers, preferably silicas, and for organic polymers, for example thermosets, thermoplastics or elastomers, or as crosslinking agent and surface modifier for oxidic surfaces.

The silane coupling agents react with the surface silanol groups of the silica or other polar groups during the mixing of the rubber/the rubber mixture (in situ) or in the context of a pretreatment (premodification) even before addition of the filler to the rubber.

Silane coupling agents that may be used here include any silane coupling agents known to those skilled in the art for use in rubber mixtures. Such coupling agents known from the prior art are bifunctional organosilanes having at least one alkoxy, cycloalkoxy or phenoxy group as a leaving group on the silicon atom and having, as another functionality, a group that, after cleavage if necessary, can enter into a chemical reaction with the double bonds of the polymer. The latter group may, for example, be one of the following chemical groups: —SCN, —SH, —NH₂ or —Sx- (with x=2 to 8).

Silane coupling agents that may be used thus include, for example, 3-mercaptopropyltriethoxysilane, 3-thiocyanatopropyltrimethoxysilane or 3,3′-bis(triethoxysilylpropyl) polysulfides having 2 to 8 sulfur atoms, for example 3,3′-bis(triethoxysilylpropyl) tetrasulfide (TESPT), the corresponding disulfide (TESPD), or else mixtures of the sulfides having 1 to 8 sulfur atoms with different contents of the various sulfides. TESPT may for example also be added as a mixture with carbon black (trade name X50S® from Evonik). Preference is given to using a silane mixture containing 40% by weight to 100% by weight of disulfides, more preferably 55% by weight to 85% by weight of disulfides and most preferably 60% by weight to 80% by weight of disulfides.

Blocked mercaptosilanes as known for example from WO 99/09036 may also be used as a silane coupling agent. It is also possible to use silanes as described in WO 2008/083241 A1, WO 2008/083242 A1, WO 2008/083243 A1 and WO 2008/083244 A1. It is also possible to use, for example, silanes which are sold under the NXT name in a number of variants from Momentive, USA, or those which are sold under the VP Si 363® name by Evonik Industries. The amount of the silane coupling agent is preferably 0.1 phf to 20 phf, more preferably 1 phf to 15 phf.

### Description of the Hydrolyzable Groups of a Silane:

(R1)oSi—R2

where:
o is 1, 2 or 3.

The R1 radicals are the same or different and are selected from the group of alkoxy groups having 1 to 10 carbon atoms, cycloalkoxy groups having 4 to 10 carbon atoms, phenoxy groups, aryl groups having 6 to 20 carbon atoms, alkyl groups having 1 to 10 carbon atoms, alkenyl groups having 2 to 20 carbon atoms, aralkyl groups having 7 to 20 carbon atoms, alkyl polyether group —O—(R3-O)r-R5 (where R3 are the same or different and are branched or unbranched, saturated or unsaturated, aliphatic, aromatic or mixed aliphatic/aromatic divalent C₁-C₃₀ hydrocarbyl groups, preferably —CH₂—CH₂—, and where r is an integer from 1 to 30, preferably 3 to 10, and R5 are unsubstituted or substituted, branched or unbranched, monovalent alkyl, alkenyl, aryl or aralkyl groups, preferably —C₁₃H₂₇ alkyl group, or halides).

It is possible here for two R1 to form a cyclic dialkoxy group having 2 to 10 carbon atoms, or it is possible for two R1 each from a different molecule to constitute a bridging oxygen atom, in which case one R1 in each molecule is an alkoxy or halide group.

The R2 radical is linear or branched alkyl groups having 1 to 20 carbon atoms, cycloalkyl groups having 4 to 12 carbon atoms, aryl groups having 6 to 20 carbon atoms, aralkyl groups having 7 to 20 carbon atoms, alkenyl groups having 2 to 20 carbon atoms or alkynyl groups having 2 to 20 carbon atoms.

The silane may have been applied to a support, for example wax, polymer or carbon black, and may have been added to the rubber mixture in that form. The silane of the invention may have been applied to a silica, in which case the attachment may be physical or chemical.

### Plasticizers/Processing Aids

Processing aids are understood to mean oils and other viscosity-lowering substances. These processing aids may, for example, be plasticizer oils or plasticizer resins.

For example, these are aromatic, naphthenic or paraffinic mineral oil plasticizers, for example MES (mild extraction solvate) or RAE (residual aromatic extract) or TDAE (treated distillate aromatic extract), or rubber-to-liquid oils (RTL) or biomass-to-liquid oils (BTL) or factices or plasticizer resins or liquid polymers (such as liquid BR), the average molar mass of which (determined by GPC=gel permeation chromatography, in accordance with BS ISO 11344:2004) is between 500 g/mol and 20 000 g/mol. If liquid polymers are used as plasticizers in the rubber mixture of the invention, these are not counted as rubber in the calculation of the composition of the polymer matrix. When mineral oil is used, it is preferably selected from the group consisting of DAE (distilled aromatic extracts) and/or RAE (residual aromatic extract) and/or TDAE (treated distilled aromatic extracts) and/or MES (mild extracted solvents) and/or naphthenic oils.

It will be clear to those skilled in the art that hydrocarbon resins are polymers constructed from monomers, wherein the hydrocarbon resin is formally constructed from derivatives of the monomers by linkage of the monomers to one another. However, these hydrocarbon resins do not count as rubbers in the context of the present invention. The term “hydrocarbon resins” in the context of the present application encompasses resins which comprise carbon atoms and hydrogen atoms and may comprise optionally heteroatoms, such as oxygen atoms in particular. The hydrocarbon resin may be a homopolymer or a copolymer. In the present application, the term “homopolymer” is understood to mean a polymer which, according to Römpp Online Version 3.28, “has formed from monomers of only one type”.

The monomers may be any monomers of hydrocarbon resins that are known to those skilled in the art, such as aliphatic C5 monomers, further unsaturated compounds capable of cationic polymerization, containing aromatics and/or terpenes, terpene-phenols and/or alkenes and/or cycloalkenes.

In a preferred embodiment of the invention, the hydrocarbon resin is selected from the group consisting of aliphatic C5 resins and hydrocarbon resins formed from alpha-methylstyrene and styrene.

The hydrocarbon resin preferably has an ASTM E 28 (ring and ball) softening point of 10° C. to 180° C., especially of 60° C. to 150° C., more preferably of 80° C. to 99° C.

In addition, the hydrocarbon resin preferably has a molar mass Mw of 500 g/mol to 4000 g/mol, preferably of 1300 g/mol to 2500 g/mol.

### Crosslinking Agent (Vulcanizing Agent)

Crosslinking agents used are preferably at least a sulfur or at least a sulfur donor, and peroxidic crosslinkers, for example organic peroxides such as dicumyl peroxide, di(2,4-dichlorobenzoyl) peroxide, tert-butyl peroxybenzoate, 1,1-di(tert-butylperoxy)-3,3,5-trimethylcyclohexane, butyl 4,4-di-(tert-butylperoxy)valerate, 2,5-dimethyl-2,5-di(tert-butylperoxy)hex-3-yne, di-tert-butyl peroxide, 2,5-dimethyl-2,5-di-(tert-butylperoxy)hexane, di(2-tert-butyl-peroxyisopropyl)benzene or tert-butyl cumyl peroxide or a combination thereof. Further alternatives used may, for example, be the crosslinking agents specified in WO 2018/191187 A1, paragraph [0094].

### Accelerators and Activators

The accelerators and the activators are optional mixture constituents; they are especially constituents of a sulfur-accelerator crosslinking system and are therefore preferably used in combination with sulfur or a sulfur donor. Possible accelerators can be found, for example, in WO 2018/191187 A1, paragraph [0094].

Sulfur or sulfur donors and one or more accelerators are added in the stated amounts to the rubber mixture in the last mixing step.

The accelerator is preferably selected from the group consisting of thiazole accelerators and/or mercapto accelerators and/or sulfenamide accelerators and/or thiocarbamate accelerators and/or thiuram accelerators and/or thiophosphate accelerators and/or thiourea accelerators and/or xanthogenate accelerators and/or guanidine accelerators.

Examples are N-cyclohexyl-2-benzothiazolesulfenamide (CBS), N,N-dicyclohexylbenzothiazole-2-sulfenamide (DCBS), benzothiazyl-2-sulfenmorpholide (MBS), N-tert-butyl-2-benzothiazylsulfenamide (TBBS), diphenylguanidine (DPG).

It is also possible to use further network-forming systems in the rubber mixture, as obtainable, for example, under the Vulkuren®, Duralink® or Perkalink® trade names, or network-forming systems as described in WO 2010/049261 A2.

### Further Optional Constituents

a) Aging stabilizers:
   e.g. N-phenyl-N′-(1,3-dimethylbutyl)-p-phenylenediamine (6PPD), N,N′-diphenyl-p-phenylenediamine (DPPD), N,N′-ditolyl-p-phenylenediamine (DTPD), N-isopropyl-N′-phenyl-p-phenylenediamine (IPPD), 2,2,4-trimethyl-1,2-dihydroquinoline (TMQ).
b) Activators:
   e.g. fatty acids (e.g. stearic acid) and/or zinc oxide (ZnO pellets or powder). The zinc oxide conventionally used generally has a BET surface area of less than 10 m²/g. It is alternatively possible to use what is called nano-zinc oxide having a BET surface area of 10 to 60 m²/g.
c) Waxes
d) Resins, especially tackifying resins
e) Masticating aids, for example 2,2′-dibenzamidodiphenyl disulfide (DBD) and
f) Processing aids, for example fatty acid salts (e.g. zinc soaps), fatty acid esters and derivatives thereof, and lipids and phospholipids, especially lecithins, for example soya lecithin.
g) Reinforcer resins, for example lignin, phenol-formaldehyde resins with hardener, and polymer resins.
h) Cobalt salts and others

In order to improve rubber-metal adhesion, the use of cobalt salts and/or a resorcinol-formaldehyde-silica system or a resorcinol-formaldehyde system as additives for rubberizing mixtures has long been known. It is also possible to use the precondensates of the resorcinol resins. Rubberizing mixtures comprising cobalt salts and a resorcinol-formaldehyde-silica system are known, for example, from KGK Kautschuk Gummi Kunststoffe No. 5/99, p. 322-328, from GAK 8/1995, p. 536 and from EP-A-1 260 384.
i) Reinforcer resins

The reinforcer resins may be based, for example, on a methylene donor, e.g. hexamethoxymethylmelamine (HMMM) or hexamethylenetetramine (HMT), and a methylene acceptor, for example on resorcinol, phenol, or a resorcinol, phenol or acetone derivative. It is possible, for example, to use methylene acceptors based on a resorcinol-formaldehyde novolac resin, a resorcinol-formaldehyde-styrene novolac resin, a phenol-formaldehyde novolac resin, for example Alnovol® products, a phenol-formaldehyde-styrene novolac resin, a phenol-formaldehyde-urethane novolac resin or an acetone novolac resin. The reinforcer resins preferably contain a proportion of unbound resorcinol of less than 0.1% and a proportion of unbound phenol of less than 1%.

The reinforcer resins may also be based exclusively on a methylene donor, e.g. hexamethoxymethylmelamine (HMMM) or hexamethylenetetramine (HMT).
j) Cobalt
   is preferably present in a steel cord adhesion system based on organic cobalt salts and reinforcer resins and more than 2.5 phr of sulfur. The organic cobalt salts are typically used in amounts of 0.2 to 2 phr. Cobalt salts used may, for example, be cobalt stearate, borate, borate-alkanoates, naphthenate, rhodinate, octoate, adipate etc.

1-15. (canceled)

16. A crosslinkable rubber mixture comprising:
a) a diene rubber having an average molar mass of more than 150 000 g/mol,
b) a filler,
c) a polymer or oligomer having an average molar mass Mn of less than 150 000 g/mol, which has a filler-interactive functional group and a glass transition temperature T_{g}<−15° C., and
d) a polymer or oligomer having an average molar mass Mn of less than 150 000 g/mol, which has a filler-interactive functional group and a glass transition temperature Tg>−15° C.

17. The rubber mixture of claim 16, further comprising silica and/or carbon black as filler.

18. The rubber mixture of claim 16, further comprising that the polymer or oligomer of feature c) is a diene-based polymer or oligomer.

19. The rubber mixture of claim 16, further comprising the polymer or oligomer of feature c) has a glass transition temperature T_{g} of <−20° C., especially of <−30° C.

20. The rubber mixture of claim 16, further comprising the polymer or oligomer of feature c) has an average molar mass Mn (number-average molar mass by gel permeation chromatography) of 500 g/mol to 50 000 g/mol, especially of 1000 g/mol to 20 000 g/mol, more preferably of 3000 g/mol to 15 000 g/mol.

21. The rubber mixture of claim 16, further comprising that the polymer or oligomer of feature c) has been functionalized with a silyl protecting group.

22. The rubber mixture of claim 16, further comprising that the polymer or oligomer of feature c) is a polybutadiene functionalized with a filler-interactive functional group.

23. The rubber mixture of claim 16, further comprising that the polymer or oligomer of feature c) and/or the polymer or oligomer of feature d) has been functionalized with a silyl protecting group of the formula (IV):
(R¹R²R³)Si— Formula IV
where
R¹, R², R³ are independently selected from the group of linear or branched alkoxy, cycloalkoxy, alkyl, cycloalkyl, aryl or hydroxyl groups, in each case having 1 to 20 carbon atoms, or hydrogen and
where the silyl protecting group of formula IV is attached directly or via a bridge to the polymer chain of the polymer or oligomer and
where the bridge is formed from a saturated or unsaturated hydrocarbyl radical that may contain heteroatoms, especially sulfur and/or nitrogen.

24. The rubber mixture of claim 16, further comprising that the polymer or oligomer of feature d) has been functionalized with a silyl protecting group of the formula V:
—[Zₖ—Xₙ—R⁴—(CH₂)ₘ—Si(R⁵)ₚ]_{q} Formula V
where
Z is an aromatic or aliphatic group, optionally having one or more heteroatom(s),
X is a linker containing sulfur and/or oxygen and/or nitrogen and/or a carbonyl group,
R⁴ is one or more aliphatic groups having 1 to 18 carbon atoms and/or a connecting group to at least one heteroatom, especially to oxygen, nitrogen or sulfur,
R⁵ is a branched or unbranched alkoxy, aryloxy, alkyl or aryl group having 1 to 18 carbon atoms, hydrogen or a hydroxyl group, where at least one R⁵ is an alkoxy or aryloxy group having 1 to 18 carbon atoms, a hydrogen atom or a hydroxyl group, where R⁵ is the same or different within the molecule,
q is an integer ≥1,
k is 0 or 1,
n is an integer from 1 to 10,
m is an integer from 0 to 10 and
p is 1, 2 or 3.

25. The rubber mixture of claim 16, further comprising that the polymer or oligomer of feature d) is a resin based on unsaturated aliphatic monomers, unsaturated aromatic monomers, terpenes, rosin, unsaturated cycloaromatic monomers, unsaturated cycloaliphatic models, unsaturated fatty acids, methacrylates and/or vinylaromatic monomers.

26. The rubber mixture of claim 16, further comprising that the polymer or oligomer of feature d) has a molar mass (Mn) of 200 g/mol to 150 000 g/mol, preferably of 200 g/mol to 50 000 g/mol, more preferably of 200 g/mol to 30 000 g/mol.

27. The rubber mixture of claim 16, further comprising that the polymer or oligomer of feature c) and the polymer or oligomer of feature d) are present in a ratio of 1:50 to 50:1.

28. The rubber mixture of claim 16, further comprising that the temperature differential ΔT_{g} ascertained between the glass transition temperature T_{g} of the polymer or oligomer of feature c) and the glass transition temperature T_{g} of the polymer or oligomer of feature d) is at least 5° C.

29. The rubber mixture of claim 16, further comprising that it contains at least one silane coupling agent.

30. The rubber mixture of claim 16, wherein the rubber mixture is incorporated into a tire tread of a pneumatic vehicle tire.
